(19) United States
(12) Patent Application Publication
(10) Pub. No.: US 2004/0231695 A1
(43) Pub. Date: Nov. 25, 2004

(54) Cleaning gas for semiconductor production equipment and cleaning method using the gas

(76) Inventors: Hiromoto Ohno, Kanagawa (JP); Toshio Ohi, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/250,924

(22) PCT Filed: Dec. 12, 2002
(86) PCT No.: PCT/JP02/13002

Related U.S. Application Data
(60) Provisional application No. 60/391,622, filed on Jun. 27, 2002.

(30) Foreign Application Priority Data
Dec. 13, 2001 (JP) 2001-379401

(51) Int. Cl. B08B 7/00

(52) U.S. Cl. 134/1; 134/1.1; 134/19; 134/2

(57) ABSTRACT

The present invention provides a cleaning gas for semiconductor or equipment for producing semiconductor or liquid crystal, comprising a fluorine gas containing 1 vol % or less of oxygen and/or oxygen-containing compound.

The cleaning gas of the present invention enables an efficient production process of semiconductor device with a high etching rate to improve the cleaning efficiency which ensures excellent cost performance.

### CROSS-REFERENCE TO RELATED APPLICATIONS

This is an application filed pursuant to 35 U.S.C. Section 111(a) with claiming the benefit of U.S. provisional application Serial No. 60/391,622 filed on Jun. 27, 2002 under the provisions of 35 U.S.C. Section 111(b), pursuant to 35 U.S.C. Section 119(e)(1).

### TECHNICAL FIELD

The present invention relates to a cleaning gas for equipment for producing semiconductors or TFT (thin film transistor) liquid crystal devices, a cleaning method using the gas, wherein unnecessary deposits accumulated inside film-forming equipment or etching equipment at the time of film formation or etching of silicon, silicon nitride, silicon oxide, tungsten and the like are removed, and also to a method for producing a semiconductor device including the cleaning step using the cleaning gas.

### BACKGROUND ART

In the film-forming equipment or etching equipment for production of semiconductor or TFT liquid crystal device, deposits accumulated at the film-formation or etching of silicon, silicon nitride, silicon oxide, tungsten and the like cause generation of particles and hinder production of good film, therefore, these deposits must be removed on occasion.

Heretofore, deposits in semiconductor production equipment are removed by a method of etching the deposits using a plasma excited from a fluorine-type etching gas such as NF₃, CF₄ and C₂F₆. However, method of using NF₃ has a problem in that the NF₃ is expensive, and method of using perfluorocarbon such as CF₄ and C₂F₆ has a problem in that the etching rate is low and the cleaning efficiency is low. Furthermore, etching methods using a etching gas such as perfluorocarbon involves emission of a large amount of unreacted gas, requiring a burden of post process of eliminating pollutional discharges and causing a problem of a high burden on the environment due to emission of greenhouse gas.

On the other hand, as a technique for increasing cleaning efficiency, method of adding O₂ to perfluorocarbon such as CF₄ and C₂F₆ is being employed, however, it is also known that excessive addition of O₂ adversely reduces cleaning efficiency. It is presumed that addition of O₂ has effects of making fluorine readily released by (1) generating COₓ or SOₓ by reacting carbon or sulfur dissociated during excitation, and (2) suppressing formation and re-formation of C—C bond or S—S bond. Though interaction between F and O is weak as compared with those between C and O or S and O, an excessive amount of oxygen(O) accelerates deactivation of F radicals.

An advantage in using F₂ gas as a cleaning gas is that process of eliminating pollutional discharges is easy. Conventional cleaning method using gases such as perfluorocarbon, and NF₃, in view of energy required, costs a lot in eliminating unreacted gas discharged in a large amount, whereas a cleaning method using F₂ is cost-effective because of its high reactivity which enables easy elimination of pollutional discharges by a conventional process generally employed.

Since process of removing deposits is based on reaction between fluorine and the deposits, if the gas to be introduced is pure fluorine, theoretically, the cleaning efficiency will exhibit the highest value.

However, purity of fluorine gases commercially available at present is low, and impurities such as HF, O₂, N₂, CO₂, H₂O, CF₄ and SF6 are contained therein. O₂, CO₂, and H₂O are likely to adversely affect cleaning process using F₂ gas, though HF can be relatively easily removed by adsorption operation and N₂, CF₄ and SF₆, which are employable as a diluting gas or an etching gas, have little adverse effects on cleaning process using F₂ gas.

### DISCLOSURE OF INVENTION

The present invention has been made under these circumstances. Accordingly, one of the objects of the present invention is to provide a cleaning gas and a cleaning method using the gas, which ensure high etching rate, high cleaning efficiency and excellent cost performance. Furthermore, another one of the objects of the present invention is to provide a method for producing a semiconductor device.

As a result of extensive investigations to solve the above-described problems, the present inventors have found that a cleaning gas comprising fluorine wherein content of oxygen and/or oxygen-containing compounds is extremely reduced enhances etching rate and improves cleaning efficiency, to thereby complete the invention.

That is, the present invention relates to a cleaning gas and a cleaning method and to a method for producing a semiconductor device, as described in (1) and (16) below.

(1) A cleaning gas for removing deposits in equipment for producing semiconductor or liquid crystal, comprising fluorine gas containing 1 vol % or less of oxygen and/or oxygen-containing compound.

(2) The cleaning gas as described in (1) above, wherein the content of oxygen and/or oxygen-containing compound contained in the fluorine gas is 0.5 vol % or less.

(3) The cleaning gas as described in (2) above, wherein the content of oxygen and/or oxygen-containing compound contained in the fluorine gas is 0.1 vol % or less.

(4) The cleaning gas as described in any one of (1) to (3) above, wherein purity of the fluorine gas is 99 vol % or more.

(5) The cleaning gas as described in (4) above, wherein purity of the fluorine gas is 99.5 vol % or more.

(6) The cleaning gas as described in any one of (1) to (3) above, wherein the oxygen-containing compound is at least one compound selected from a group consisting of NO, N₂O, NO₂, CO, CO₂, H₂O, OF₂, O₂F₂ and O₃F₂.

(7) The cleaning gas as described in (6) above, wherein the oxygen-containing compound is at least one compound selected from a group consisting of CO, CO₂ and H₂O.

(8) The cleaning gas as described in any one of (1) to (7) above, comprising at least one diluting gas selected from a group consisting of He, Ar, N₂, Ne, Kr and Xe.

(9) The cleaning gas as described in (8) above, comprising at least one diluting gas selected from a group consisting of He, Ar and N₂.

(10) A method for cleaning production equipment of semiconductors or liquid crystal devices, using the cleaning gas as described in any one of (1) to (9) above.

(11) The cleaning method as described in (10) above, wherein the cleaning gas described in any one of (1) to (9) above is excited to produce plasma and the deposits in the semiconductor production equipment are removed in the plasma.

(12) The cleaning method as described in (11) above, wherein the excitation source for the plasma is a microwave.

(13) The cleaning method as described in (10) above, wherein the cleaning gas is used at a temperature range of 50 to 500° C.

(14) The cleaning method as described in (10) above, wherein the cleaning gas is used at a temperature range of 200 to 500° C. in a plasmaless system.

(15) A method for producing a semiconductor device, comprising a cleaning step of using the cleaning gas as described in any one of (1) to (9) above and a decomposition step of decomposing a fluoro compound-containing gas discharged from the cleaning step.

(16) The method for producing a semiconductor device as described in (15) above, wherein the fluoro compound is at least one compound selected from a group consisting of SiF₄, HF, CF₄, NF₃ and WF₆.

### BRIEF DESCRIPTION OF DRAWING

FIG. 1 is a schematic view of etching equipment using the cleaning gas of the present invention.

### DETAILED DESCRIPTION OF INVENTION

The present invention is described in detail below.

The cleaning gas for production equipment for semiconductor or liquid crystal devices of the present invention comprises a fluorine gas containing 1 vol % or less of oxygen and/or oxygen-containing compounds.

In the cleaning gas for production equipment for semiconductor, the content of oxygen and/or oxygen-containing compounds contained in the fluorine gas is preferably 0.5 vol % or less, more preferably 0.1 vol % or less. If the content of oxygen and/or oxygen-containing compounds in the fluorine gas exceeds 1 vol %, cleaning efficiency is unpreferably reduced.

The oxygen-containing compound is, for example, one or more compounds selected from a group consisting of NO, N₂O, NO₂, CO, CO₂, H₂O, OF₂, O₂F₂ and O₃F₂, and the cleaning gas of the present invention is characterized in comprising fluorine gas containing oxygen and/or oxygen-containing compound at 1 vol % or less. The oxygen-containing compound may be one or more compounds selected from a group consisting of CO, CO₂ and H₂O.

Purity of fluorine gas, determined by eliminating oxygen and/or oxygen-containing compound contained therein as impurities, is preferably 99 vol % or more, more preferably 99.5 vol % or more. Further, though the cleaning gas of the present invention contains fluorine gas having 1 vol % or less. of oxygen and/or oxygen-containing compound preferably without diluting the fluorine gas, the fluorine gas may be diluted if necessary under some cleaning conditions. Gas for diluting the fluorine gas is preferably at least a diluting gas selected from a group consisting of He, Ar, N₂, Ne, Kr and Xe, more preferably at least a diluting gas selected from a group consisting of He, Ar and N₂.

In the case of cleaning semiconductor production equipment using the cleaning gas of the present invention, the gas may be used under the plasma condition or under the plasmaless condition.

When the gas is used under the plasma condition, the excitation source is not particularly limited as long as plasma is excited from the cleaning gas of the present invention, but a microwave excitation source is preferred because good cleaning efficiency can be attained. Also, the temperature and the pressure when the cleaning gas of the present invention is used are not particularly limited as long as plasma can be produced, but the temperature range is preferably from 50 to 500° C. and the pressure range is preferably from 1 to 500 Pa.

In the case of plasmaless condition, the cleaning gas is introduced into a chamber, the inner pressure of the chamber is preferably set to 1 to 500 Pa and at least a part of or either one of the inside of chamber and the cleaning gas is heated at 200 to 500° C. to activate the cleaning gas. Then, deposits are etched and removed from the chamber and from other regions where deposits are accumulated, and thereby the semiconductor production equipment can be cleaned.

In the cleaning gas for semiconductor production equipment of the present invention,

(1) F₂ gas capable of dissociating at a low energy level and producing an active species is contained in the gas, and

(2) the content of oxygen and/or oxygen-containing compound contained therein, which have adverse effects on generation and sustainment of fluorine free radicals, is reduced to the minimum. By these features, the present invention exhibits more advantageous effects than conventionally used NF₃ gas. As compared to NF₃ gas, F₂ dissociates at a low energy level and at the time of complete dissociation, produces only F radicals. Therefore, since it is only active species which exists in the system when cleaning is performed, reaction efficiency with deposits accumulated therein is extremely high.

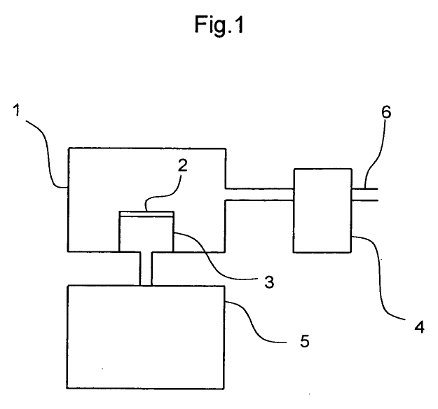

FIG. 1 is a view showing one example of the etching equipment using the cleaning gas of the present invention. The cleaning gas is introduced into a chamber 1 set at a constant temperature from a cleaning gas inlet 6 and at this time, the gas is excited by a microwave plasma excitation source 4 and produces plasma. The gas obtained after the etching-of a silicon wafer 2 on sample stage 3 is discharged by a dry pump 5 and rendered harmless using a decomposing agent according to the kind of the gases contained therein. Furthermore, the deposits accumulated after the etching are efficiently removed by repeating the same operation as the etching, and thereby the chamber can be efficiently cleaned.

Next, production process for semiconductor device of the present invention will be described.

As aforementioned, according to the present invention, cleaning of semiconductor production equipment can be efficiently performed. However, gas discharged during the cleaning process using the cleaning gas of the present invention contains, in addition to F₂ gas used for cleaning, fluoro compounds such as HF, CF₄, SiF₄, NF₃ and WF₆. These compounds, containing F₂ which greatly affect global warming if released to the atmosphere as they are or generate acidic gas if decomposed, need to be rendered completely harmless. The present invention provides a production process for semiconductor device comprising a cleaning step of semiconductor production equipment and a decomposition step of decomposing a fluoro compound-containing gas discharged from the cleaning step in a production process for semiconductor device.

A cleaning step of semiconductor production equipment can be performed using the aforementioned method. Moreover, method employed in a decomposing step of gas containing fluoro compound discharged from the cleaning step is not particularly limited and decomposing agent may be selected according to the kind of compound contained in the discharged gas. Preferably, hydrogen fluoride is released after stabilized as a metal fluoride and carbon is released after decomposed to be carbon dioxide.

### BEST MODE FOR CARRYING OUT INVENTION

The present invention is described in greater detail below by referring to the Examples and Comparative Example, however, the present invention is not limited to these Examples.

### EXAMPLES 1 TO 2

A testing apparatus shown in FIG. 1 was adjusted to an apparatus inner pressure of 300 Pa. A cleaning gas having the composition shown in Table 1 was excited by a microwave plasma excitation source of 2.45 GHz and 500 W and then introduced into the testing apparatus to etch a silicon wafer placed in the testing apparatus. The etching rate was determined from the loss in volume of the silicon wafer after etching and the results are shown in Table 1.

TABLE 1

| | Gas Used and | | |
|---|---|---|---|
| | Mixing Ratio | | |
| | (Volume %) | | Etching Rate |
| Example | F₂ | O₂ | (nm/mm) |
| 1 | 100 | 0 | 2000 |
| 2 | 99 | 1 | 1800 |

It is revealed that F₂ gas containing 1 vol % or less of oxygen exhibited a remarkably high etching rate.

### COMPARATIVE EXAMPLE 1

The etching rate of each cleaning gas was determined in the same manner as in Example 1 except that the cleaning gas was changed to a gas having composition shown in Table 2.

TABLE 2

| | Gas Used and | | |
|---|---|---|---|
| | Mixing Ratio | | |
| Comparative | (Volume Ratio) | | Etching Rate |
| Example | F₂ | O₂ | (nm/mm) |
| 1 | 95 | 5 | 1200 |

It is revealed that the etching rate was greatly reduced when F₂ gas contained 5 vol % or more of oxygen.

### EXAMPLE 3

In place of a silicon wafer, a quartz piece having accumulated thereon deposits of amorphous silicon, silicon nitride and the like was subjected to cleaning. The cleaning gas as used in Example 1 was excited by a microwave plasma excitation source of 2.45 GHz and 500 W and introduced into a chamber of a testing apparatus adjusted to an inner pressure of 300 Pa, and the quartz piece was cleaned and then taken out. As a result, it was confirmed that the deposits were completely removed.

Industrial Applicability

The cleaning gas for semiconductor production equipment of the present invention is high in the etching rate, therefore, ensures efficient cleaning and excellent cost performance. According to the method for cleaning semiconductor production equipment of the present invention, unnecessary deposits in the film-forming equipment or etching equipment for the production of a semiconductor or a TFT liquid crystal element accumulated at the time of film-formation or etching of silicon, silicon nitride, silicon oxide, tungsten or the like can be efficiently removed. Furthermore, by using the method comprising a cleaning step of using the cleaning gas of the present invention and a step of decomposing and thereby rendering harmless the fluoro compound-containing exhaust gas discharged from the cleaning step, a semiconductor device can be efficiently produced.

1. A cleaning gas for removing deposits in equipment for producing semiconductor or liquid crystal, comprising fluorine gas containing 1 vol % or less of oxygen and/or oxygen-containing compound.

2. The cleaning gas as claimed in claim 1, wherein the content of oxygen and/or oxygen-containing compound contained in the fluorine gas is 0.5 vol % or less.

3. The cleaning gas as claimed in claim 2, wherein the content of oxygen and/or oxygen-containing compound contained in the fluorine gas is 0.1 vol % or less.

4. The cleaning gas as claimed in any one of claims 1 to 3, wherein purity of the fluorine gas is 99 vol % or more.

5. The cleaning gas as claimed in claim 4, wherein purity of the fluorine gas is 99.5 vol % or more.

6. The cleaning gas as claimed in any one of claims 1 to 3, wherein the oxygen-containing compound is at least one compound selected from a group consisting of NO, N₂O, NO₂, CO, CO₂, H₂O, OF₂, O₂F₂ and O₃F₂.

7. The cleaning gas as claimed in claim 6, wherein the oxygen-containing compound is at least one compound selected from a group consisting of CO, CO₂ and H₂O.

8. The cleaning gas as claimed in any one of claims 1 to 7, comprising at least one diluting gas selected from a group consisting of He, Ar, N₂, Ne, Kr and Xe.

9. The cleaning gas as claimed in claim 8, comprising at least one diluting gas selected from a group consisting of He, Ar and N₂.

10. A method for cleaning production equipment of semiconductors or liquid crystal devices, using the cleaning gas as described in any one of claims 1 to 9.

11. The cleaning method as claimed in claim 10, wherein the cleaning gas as described in any one of claims 1 to 9 is excited to produce plasma and the deposits in the semiconductor production equipment are removed in the plasma.

12. The cleaning method as claimed in claim 11, wherein the excitation source for-the plasma is a microwave.

13. The cleaning method as claimed in claim 10, wherein the cleaning gas is used at a temperature range of 50 to 500° C.

14. The cleaning method as claimed in claim 10, wherein the cleaning gas is used at a temperature range of 200 to 500° C. in a plasmaless system.

15. A method for producing a semiconductor device, comprising a cleaning step of using the cleaning gas as described in any one of claims 1 to 9 and a decomposition step of decomposing a fluoro compound-containing gas discharged from the cleaning step.

16. The method for producing a semiconductor device as claimed in claim 15, wherein the fluoro compound is at least one compound selected from a group consisting of SiF₄, HF, CF₄, NF₃ and WF₆.
